(19) United States
(12) Patent Application Publication
(10) Pub. No.: US 2025/0105564 A1
(43) Pub. Date: Mar. 27, 2025

(54) ELECTRICAL POWER CONNECTOR

(71) Applicant: Molex, LLC, Lisle, IL (US)

(72) Inventors: Michael A Bandura, Naperville, IL (US); Jay S. Kruger, Geneva, IL (US)

(21) Appl. No.: 18/829,333

(22) Filed: Sep. 10, 2024

Related U.S. Application Data
(60) Provisional application No. 63/540,518, filed on Sep. 26, 2023.

(51) Int. Cl. H01R 13/74; H01R 13/648

(52) U.S. Cl. CPC H01R 13/74; H01R 13/648

(57) ABSTRACT

In an embodiment, an electrical power connector includes an insulative body having a rear section, first and second spaced apart arms extending from the rear section, and a flange. A ground terminal extends along a front surface of the flange and along an outer surface of the first arm. Power terminals are mounted on the arms and extend along an inner surfaces thereof. An entrance space is defined between the power terminals.

### TECHNICAL FIELD

This disclosure relates to a panel mounted electrical power connector. The electrical power connector is suitable for coupling a busbar to a wiring harness.

### DESCRIPTION OF RELATED ART

Mounting hardware is used to mount an electrical power connector to a panel. As a result of the use of the mounting hardware, the electrical power connector occupies a large amount of space. It is desirable to minimize the amount of space that the electrical power connector and its mounting means occupy. In addition, fasteners are used to attach the electrical power connector to the panel. This increases the amount of time needed to assemble the electrical power connector to the panel. It is further desirable to minimize the amount of time taken to assemble the electrical power connector with the panel.

### SUMMARY

In an embodiment, an electrical power connector includes an insulative body defining at least one passageway therethrough, the body including a rear section, first and second spaced apart arms extending from a front end of the rear section, and a flange extending outward from the rear section; a ground terminal mounted on the body, the ground terminal extending along a front surface of the flange and further extending along an outer surface of the first arm; a first power terminal mounted on the first arm and extending along an inner surface thereof; and a second power terminal mounted on the second arm and extending along an inner surface thereof. An entrance space is defined between the power terminals which is continuous with the at least one passageway.

A plurality of flexible legs of the ground terminal extend along the front surface of the flange, and a plurality of flexible fingers of the ground terminal extend along the first arm.

A panel is provided and includes coupled first and second walls. The arms and the flexible fingers extend through the first wall, the rear section extends through the second wall, and the flexible legs and the flange are captured between the first and second walls.

The first wall has a first opening which is larger than an outer profile of the arms, and the second wall has an opening which is larger than an outer profile of the rear section. A freedom of movement of ±3.00 mm is provided in a horizontal plane between the electrical power connector and the panel, and a freedom of movement ±2.00 mm is provided in a vertical plane between the electrical power connector and the panel. A busbar and a wiring harness are electrically coupled to the power terminals.

The ground terminal includes a mounting portion coupled to the flange, and the plurality of flexible legs and the plurality of flexible fingers extend from the mounting portion. The plurality of flexible legs may include an upper flexible leg which extends vertically upward and a lower flexible leg which extends vertically downward.

A second ground terminal including a plurality of flexible legs extending along the front surface of the flange and a plurality of flexible fingers extending along the second arm may be provided. The arms and the flexible fingers of the ground terminals extend through the first wall of the panel, the rear section extends through the second wall of the panel, and the flexible legs and the flange are captured between the first and second walls. Each ground terminal includes a mounting portion coupled to the flange, and the plurality of flexible legs and the plurality of flexible fingers extend from the mounting portion in each ground terminal.

Each power terminal includes a mounting portion; and a plurality of spaced apart flexible fingers extending longitudinally forward from the mounting portion. The mounting portion of the first power terminal is coupled to the first arm and flexible fingers of the first power terminal extend along the first arm. The mounting portion of the second power terminal is coupled to the second arm and flexible fingers of the second power terminal extend along the second arm. A busbar and a wiring harness are electrically coupled to the power terminals. The busbar seats within the entrance space and engages with the fingers of the power terminals. The busbar is part of a busbar assembly which further comprises a ground pad, and wherein the ground pad is electrically coupled to the ground terminal.

### BRIEF DESCRIPTION OF THE DRAWINGS

The present application is illustrated by way of example and not limited in the accompanying figures in which like reference numerals indicate similar elements and in which:

FIGS. 1 and 2 depict front and rear perspective views of an electrical power connector in accordance with an embodiment of the present disclosure;

FIG. 3 depicts a top plan view of the electrical power connector;

FIG. 4 depicts a front elevation view of the electrical power connector;

FIG. 5 depicts a side elevation view of a conductive ground terminal of the electrical power connector;

FIG. 6 depicts a front elevation view of the conductive ground terminal;

FIG. 7 depicts a side elevation view of a conductive power terminal of the electrical power connector;

FIG. 8 depicts a top plan view of the conductive power terminal;

FIG. 9 depicts a perspective view of a panel in which the electrical power connector is configured to be mounted;

FIG. 10 depicts a perspective view of the electrical power connector mounted within the panel of FIG. 9;

FIG. 11 depicts a perspective exploded view of the electrical power connector and the panel of FIG. 9;

FIG. 12 depicts a front elevation view of the electrical power connector mounted within the panel of FIG. 9;

FIG. 13 depicts a cross-sectional view along line 13-13 in FIG. 12; and

FIG. 14 depicts a cross-sectional view of the electrical power connector mounted within the panel of FIG. 9 which is transverse to the cross-section shown in FIG. 13, and including a busbar assembly and a wiring harness, each of which are shown in cross-section.

### DETAILED DESCRIPTION

While the disclosure may be susceptible to embodiments in different forms, it is shown in the drawings and herein which is described in detail, specific embodiments with the understanding that the present disclosure is to be considered an exemplification of the principles of the disclosure and is not intended to limit the disclosure to that as illustrated and described herein. Therefore, unless otherwise noted, features disclosed herein may be combined to form additional combinations that were not otherwise shown for purposes of brevity. It will be further appreciated that in some embodiments, one or more elements illustrated by way of example in a drawing(s) may be eliminated and/or substituted with alternative elements within the scope of the disclosure.

Directional terms such as front, rear, horizontal, vertical and the like are used for ease in explanation, and do not denote a required orientation in use.

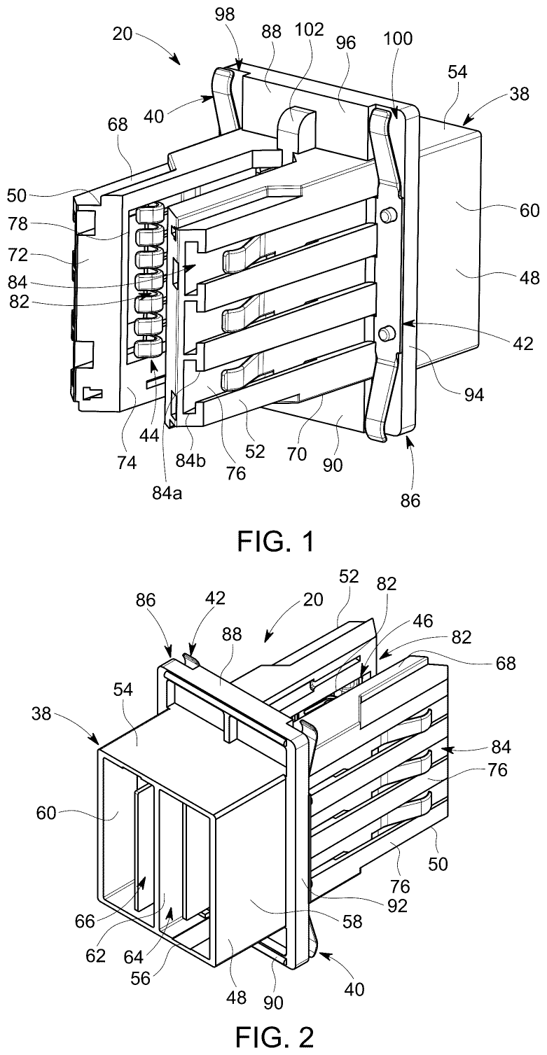

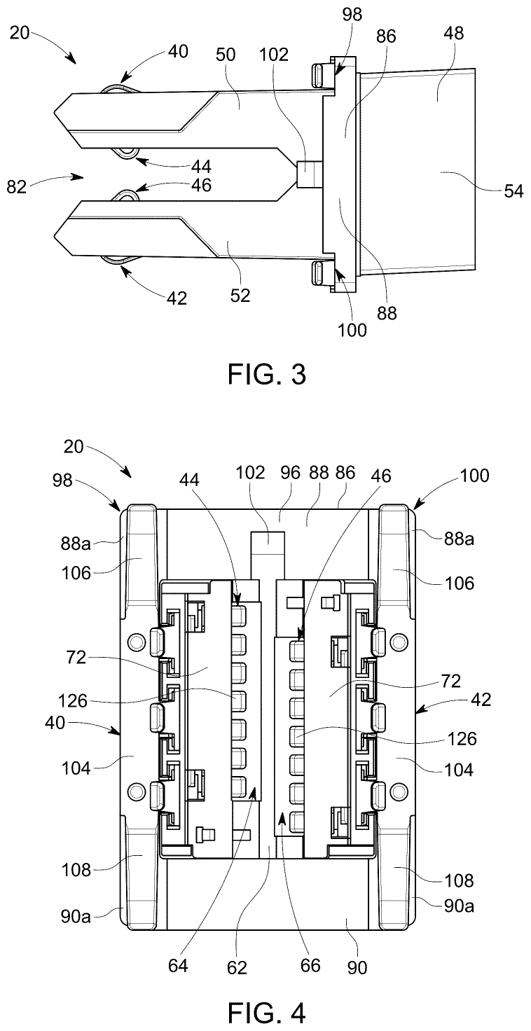

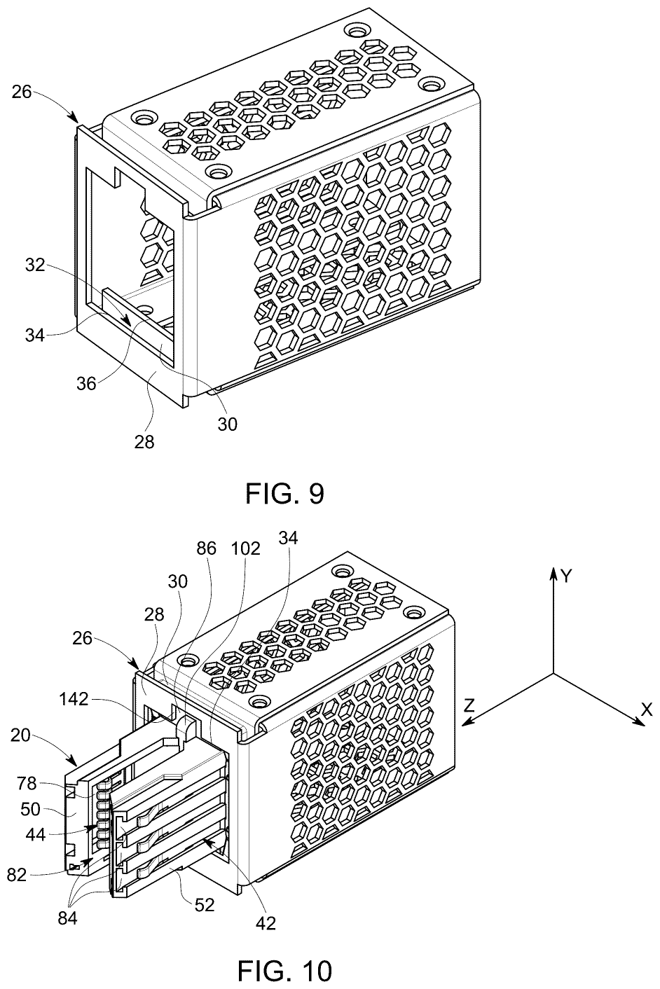

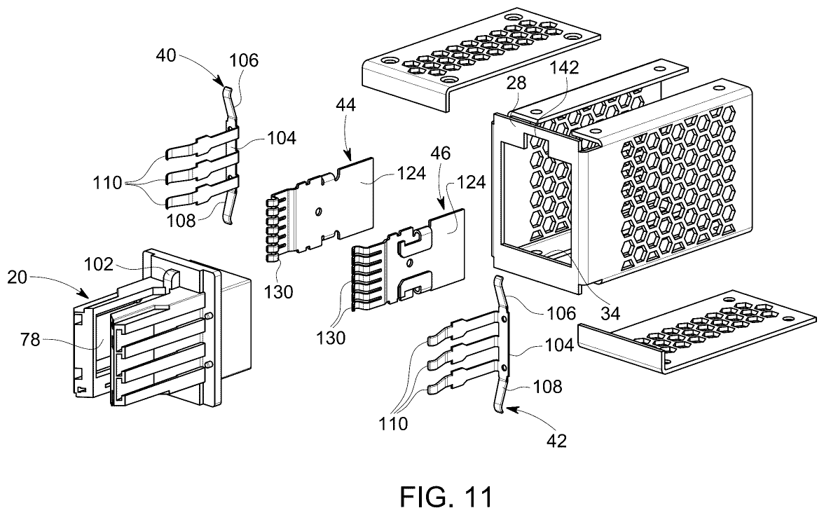

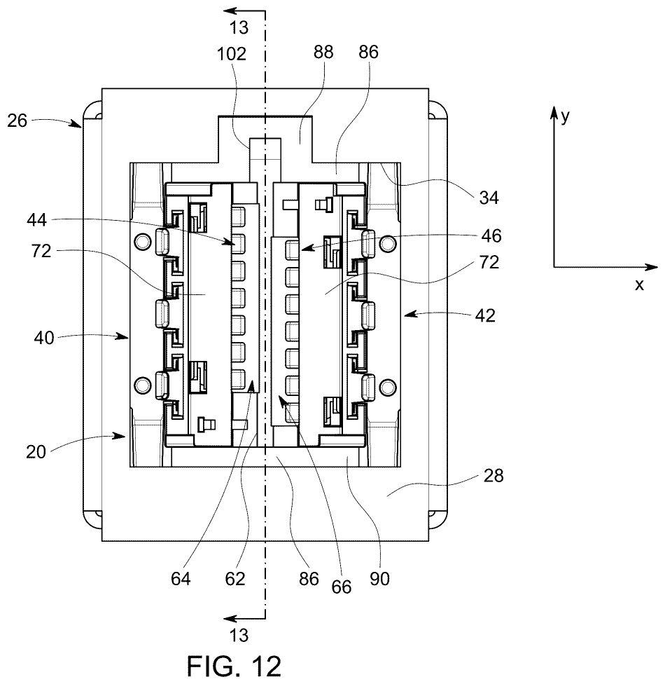

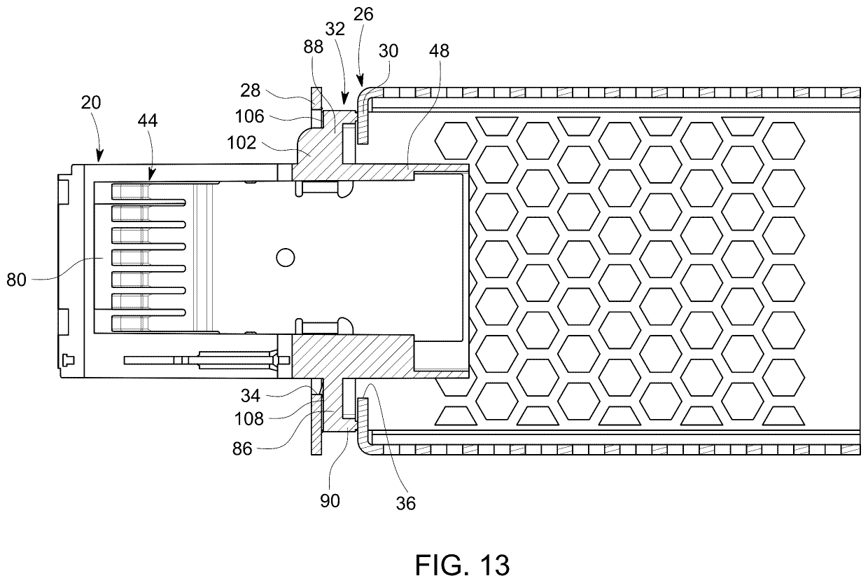

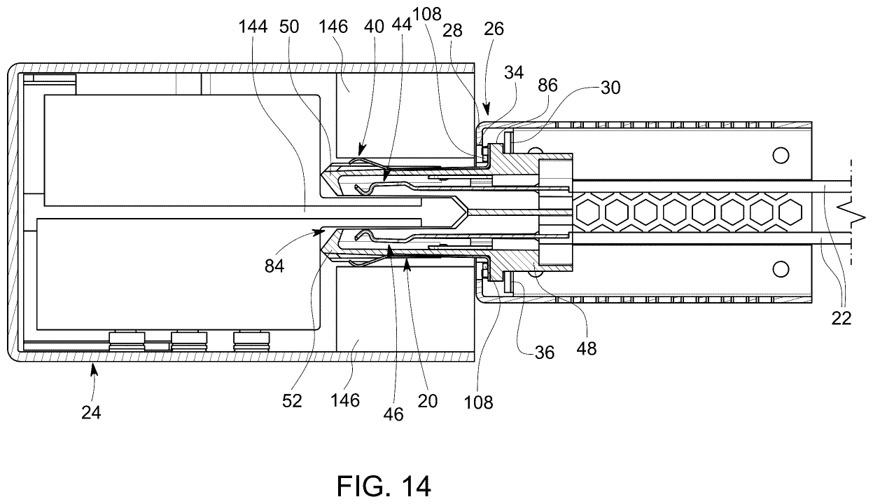

An electrical power connector 20, see FIGS. 1-4, is provided for coupling two components together, such as a wiring harness 22 with a busbar assembly 24, see FIG. 14. In use, the electrical power connector 20 is coupled to a conductive grounding panel 26 and is configured to move relative to the panel 26 in a horizontal (x) direction and in a vertical (y) direction, while being prevented from movement in a longitudinal (z) direction. The panel 26, see FIGS. 9 and 11, includes coupled and spaced apart front and rear walls 28, 30 and the power connector 20 is mounted within a space 32 between the coupled walls 28, 30, and extends through openings 34, 36 in the walls 28, 30. Separate mounting hardware is not provided, thereby minimizing the amount of space taken up by the electrical power connector 20 on the panel 26.

The power connector 20 includes an insulative body 38, a pair of deflectable conductive ground terminals 40, 42 mounted on the body 38, and a pair of deflectable conductive power terminals 44, 46 mounted on the body 38. The body 38 has a rear section 48 and first and second spaced apart arms 50, 52 extending forward from a front end of the rear section 48.

The rear section 48 has a top wall 54, an opposite bottom wall 56, first and second side walls 58, 60 extending between opposite side edges of the top and bottom walls 54, 56, and an intermediate wall 62 extending between midpoints of the top and bottom walls 54, 56. First and second longitudinally extending passageways 64, 66 are defined by the walls 54, 56, 58, 60, 62 and extend from a rear end of the rear section 48 to a front end of the rear section 48. While first and second passageways 64, 66 are shown, the intermediate wall 62 can be eliminated and a single passageway is provided.

Each arm 50, 52 extends from the front end of the rear section 48 in the longitudinal direction. The first arm 50 extends from the front end of the rear section 48 on an outer side of the first passageway 64, and the second arm 52 extends from the front end of the rear section 48 on an outer side of the second passageway 66. Each arm has 50, 52 has a top surface 68, an opposite bottom surface 70, a front surface 72 extending between front ends of the top and bottom surfaces 68, 72, and opposite inner and outer side surfaces 74, 76 extending between surfaces 68, 70, 72. The inner side surfaces 74 face each other. A pocket 78, 80 is provided in the respective inner side surface 74 in which the respective power terminal 44, 46 is seated. An entrance slot 82 is provided between the inner side surfaces 74 of the arms 50, 52 and is continuous with the pockets 78, 80 and the passageways 64, 66. One or more longitudinally extending elongated slots 84 (which are spaced apart if two or more are provided) are provided in each outer side surface 76 and open to each side. Each slot 84 has a longitudinally extending inner section 84a and a longitudinally extending outer section 84b. The inner section 84a extends vertically above and below the outer section 84b.

A flange 86 extends outward from the rear section 48 at the front end thereof and extends outward of the arms 50, 52. The flange 86 has a top section 88 which extends upward from the top wall 54, a bottom section 90 which extends downward from the bottom wall 56, a first side section 92 which extends outward from the first side wall 58, and a second side section 94 which extends outward from the second side wall 60. Outer portions 88a, 90a, see FIG. 4, of each of the top and bottom sections 88, 90 which vertically align with the respective side sections 92, 94 have lengths in the longitudinal direction which is less than a middle portion 96 of each of the top and bottom sections 88, 90. The first and second side sections 92, 94 have a length in the longitudinal direction which is the same as the outer portions 88a, 90a. This defines first and second recessed portions 98, 100 of the flange 86. A key 102 extends upward from a rear end of the arms 50, 52 and forward from the middle portion 96 of the top section 88. The key 102 may have a height equal to or less than the top section 88.

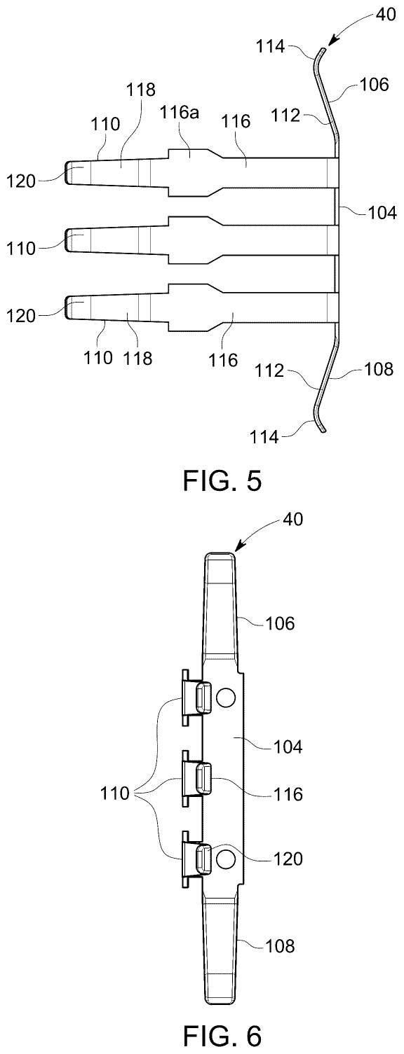

The first ground terminal 40 is mounted to the first recessed portion 98, and the second ground terminal 42 is mounted to the second recessed portion 100. Each ground terminal 40, 42 (see FIGS. 5 and 6 which show ground terminal 40 specifically) is formed of a planar back mounting portion 104 having an inner edge and an outer edge, an upper flexible leg 106 extending vertically upward from an upper end of the back mounting portion 104, a lower flexible leg 108 extending vertically downward from a lower end of the back mounting portion 104, and one or more flexible fingers 110 (which are spaced apart if two or more are provided) extending longitudinally forward from the inner edge thereof such that the flexible fingers 110 are generally perpendicular to the back mounting portion 104. Each of the upper and lower flexible legs 106, 108 has a portion 112 that is angled relative to the back mounting portion 104 and a curved end portion 114. Each finger 110 has a planar rear portion 116 extending from the back mounting portion 104, an angled intermediate portion 118 extending from the rear portion 116 and which is angled relative thereto, and a curved end portion 120 extending from the intermediate portion 118.

The back mounting portion 104 of the first ground terminal 40 seats against and is secured to the first recessed portion 98, the upper and lower flexible legs 106, 108 seat proximate to the first recessed portion 98, the rear portions 116 seat against the outer side surface 74 of the first arm 50 and is secured thereto, and the fingers 110 seat proximate to the outer side surface 74 of the first arm 50. Likewise, the back mounting portion 104 of the second ground terminal 42 seats against and is secured to the second recessed portion 100, the upper and lower flexible legs 106, 108 seat proximate to the second recessed portion 96, the rear portions 116 seat against the outer side surface 76 of the second arm 52 and is secured thereto, and the fingers 110 seat proximate to the outer side surface 76 of the second arm 52. As shown, the fingers 110 seat within the elongated slots 84 in the outer surfaces 76 of the arms 50, 52. Each rear portion 116 has an enlarged area 116a which seats within the inner section 84a of the slot 84 which holds the fingers 110 within the slots 84. The intermediate portion 118 and the curved end portion 120 of each finger 110 extends through the outer section 84b.

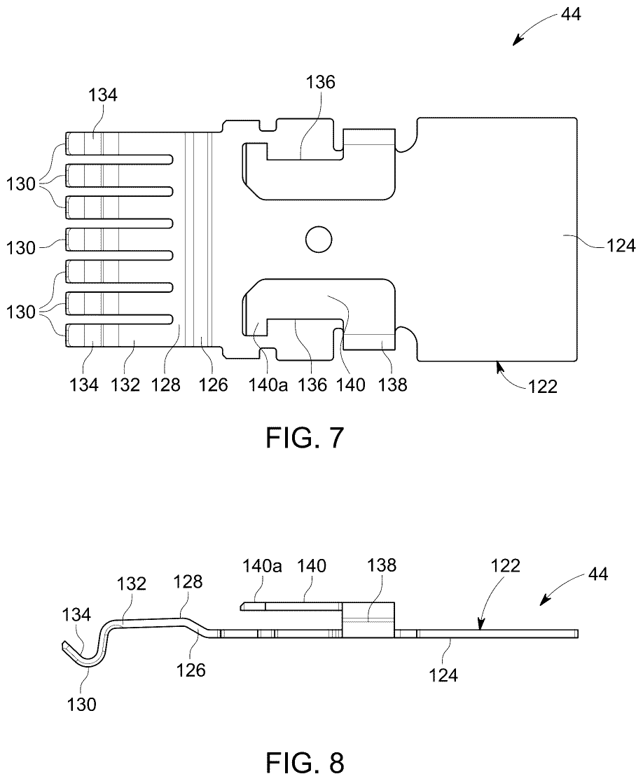

The first power terminal 44 is mounted within the pocket 78 of the first arm 50, and the second power terminal 46 is mounted within the pocket 80 of the second arm 52. Each power terminal 44, 46 (see FIGS. 7 and 8 which show power terminal 44 specifically) includes a mounting portion 122 including a planar back mounting portion 124 having a top edge and a bottom edge, an intermediate mounting portion 126 extending longitudinally from a front end of the back mounting portion 124 and at an angle relative thereto, a forward mounting portion 128 extending longitudinally from a front end of the intermediate mounting portion 126 and at an angle relative thereto, and further includes a plurality of spaced apart flexible fingers 130 extending longitudinally forward from the front end of the forward mounting portion 128. The back mounting portion 124 and the forward mounting portion 128 are parallel to each other. Each finger 130 has a planar rear portion 132 extending from the forward mounting portion 128, and a curved end portion 134 extending from the rear portion 132. The mounting portion 122 of each power terminal 44, 46 further includes a mounting arm portion 136 extending from the top and the bottom of the back mounting portion 124. Each mounting arm portion 136 has a first section 138 which extends outward from the back mounting portion 124 and is perpendicular thereto, a second section 140 extending from the opposite end of the first section 138 and is perpendicular thereto, and a hook end 140a at the front end of the second section 140. The second sections 140 are parallel to the back mounting portion 124.

The mounting portion 124 of the first power terminal 44 is secured within the pocket 78 by the mounting arm portions 136 engaging with tabs (not shown) within the pocket 78 of the first arm 50. The fingers 130 of the first power terminal 44 are proximate to, but spaced from the inner side surface 74 forming the pocket 78. Likewise, the back mounting portion 124 of the second power terminal 46 is secured within the pocket 80 of the second arm 52 by the mounting arm portions 136 engaging with tabs (not shown) within the pocket 80. The fingers 110 of the second power terminal 46 are proximate to, but spaced from the inner surface 74 forming the pocket 80. The curved end portions 134 of the power terminals 44, 46 extend into the entrance slot 82 between the arms 50, 52.

The curved end portions 120 of the ground terminals 40, 42 and the curved end portions 134 of the power terminals 44, 46 may be longitudinally aligned.

The opening 34 through the first wall 28 of the panel 26 generally conforms in shape to the rear of the arms 50, 52, including the key 102, but is slightly larger than this profile and is smaller than the flange 86, see FIG. 9. The opening 36 through the second wall 30 of the panel 26 generally conforms in shape to the rear section 48 of the body 38, but is slightly larger than this profile and is smaller than the flange 86. In an embodiment, the opening 36 through the second wall 30 of the panel 26 is larger than the opening 34 through the first wall 28. In the specific embodiment shown, the second wall 30 is shown as two separate parts, and the panel 26 is formed as an enclosure having top, bottom and side walls coupled to the first and second walls 28, 30 and having an open rear end.

The rear section 48 of the body 38 extends through the opening 36, the arms 50, 52 extend through the opening 34, and the flange 86 seats within the space 32 between the walls 28, 30. A rear end of the flange 86 engages against a front surface of the second wall 30, and the flexible legs 106, 108 of the ground terminals 40, 42, specifically the curved end portions 114, compress between, and engage, the flange 86 and a rear surface of the first wall 28. This affixes the power connector 20 to the panel 26, and prevents movement of the power connector 20 in the z-direction since the flange 86 is captured between the walls 28, 30. Since the opening 34 is larger than the outer profile of the arms 50, 52 and the key 102, and the opening 36 is larger than the outer profile of the rear section 48, the power connector 20 can move or “float” relative to the panel 26 in the plane defined in the x-direction and in the y-direction. This allows the power connector 20 to move relative to the panel 26 to compensate for any misalignment with the busbar assembly 24. The key 102 seats within a keyway extension 142 of the opening 34 in the first wall 28 and indicates the proper orientation of the power connector 20 within the panel 26. In an embodiment, the front opening 34 and the keyway extension 142 and the rear opening 36 allow for freedom of movement in the horizontal plane, e.g. ±3.00 mm, and freedom of movement in the vertical plane, e.g. ±2.00 mm. The key 102 and keyway extension 142 can be eliminated. Since fasteners are not used to attach the electrical power connector 20 to the panel 26, the assembly time is improved over the prior art.

In use, the wiring harness 22 is electrically coupled to the power terminals 44, 46. A busbar 144 of the busbar assembly 24 seats within the entrance slot 82 between the power terminals 44, 46 and causes the curved end portions 134 to deflect into the pockets 78, 80. The curved end portions 134 engage firmly against the busbar 144. The curved end portions 120 of the ground terminals 40, 42 seat against ground pads 146 of the busbar assembly 24.

To assemble the electrical connector 20 with the panel 26, the front wall 28 is positioned around the arms 50, 52 to abut against the upper and lower flexible legs 106, 108 of the ground terminals 40, 42, and the rear wall 30 is positioned around the rear section 48 to abut against the rear surface of the flange 86. The walls 28, 30 are coupled together to capture the flange 86 between the walls 28, 30. The upper and lower flexible legs 106, 108 of the ground terminals 40, 42 are compressed to prevent movement of the power connector 20 in the z-direction.

While the ground terminals 40, 42 are shown as two separate terminals, the ground terminals 40, 42 may be integrally formed as a single terminal.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All processes described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof are encompassed by the disclosure unless otherwise indicated herein or otherwise clearly contradicted by context. As can be appreciated from the various embodiments depicted herein, different features of different embodiments depicted herein can be combined together to form additional combinations. As a result, the embodiments depicted herein are particularly suitable to provide a wide range of configurations that were not all depicted individually so as to avoid repetitiveness and unnecessary duplication.

The disclosure provided herein describes features in terms of preferred and exemplary embodiments thereof. Numerous other embodiments, modifications and variations within the scope and spirit of the appended claims will occur to persons of ordinary skill in the art from a review of this disclosure.

We claim:

1. An electrical power connector comprising:
an insulative body defining at least one passageway therethrough, the body including a rear section, first and second spaced apart arms extending from a front end of the rear section, and a flange extending outward from the rear section;
a ground terminal mounted on the body, the ground terminal extending along a front surface of the flange and further extending along an outer surface of the first arm;
a first power terminal mounted on the first arm and extending along an inner surface thereof; and
a second power terminal mounted on the second arm and extending along an inner surface thereof, and
wherein an entrance space is defined between the power terminals which is continuous with the at least one passageway.

2. The electrical power connector of claim 1, wherein
a plurality of flexible legs of the ground terminal extend along the front surface of the flange; and
a plurality of flexible fingers of the ground terminal extend along the first arm.

3. The electrical power connector of claim 2, in combination with a panel comprising coupled first and second walls, the arms and the flexible fingers of the ground terminal extending through the first wall, the rear section extending through the second wall, and the flexible legs and the flange are captured between the first and second walls.

4. The combination of claim 3, wherein the first wall has a first opening which is larger than an outer profile of the arms, and the second wall has an opening which is larger than an outer profile of the rear section.

5. The combination of claim 4, wherein a freedom of movement of ±3.00 mm is provided in a horizontal plane between the electrical power connector and the panel, and a freedom of movement ±2.00 mm is provided in a vertical plane between the electrical power connector and the panel.

6. The combination of claim 2, further comprising a busbar and a wiring harness electrically coupled to the power terminals.

7. The electrical power connector of claim 2, wherein the ground terminal includes a mounting portion coupled to the flange, and the plurality of flexible legs and the plurality of flexible fingers extend from the mounting portion.

8. The electrical power connector of claim 2, wherein the plurality of flexible legs includes an upper flexible leg which extends vertically upward and a lower flexible leg which extends vertically downward.

9. The electrical power connector of claim 2, wherein the ground terminal comprises a first ground terminal, and further comprising a second ground terminal, the second ground terminal including a plurality of flexible legs extending along the front surface of the flange and a plurality of flexible fingers extending along the second arm.

10. The electrical power connector of claim 9, in combination with a panel comprising coupled first and second walls, the arms and the flexible fingers of the ground terminals extending through the first wall, the rear section extending through the second wall, and the flexible legs and the flange are captured between the first and second walls.

11. The combination of claim 10, wherein the first wall has a first opening which is larger than an outer profile of the arms, and the second wall has an opening which is larger than an outer profile of the rear section.

12. The combination of claim 11, wherein a freedom of movement of ±3.00 mm is provided in a horizontal plane between the electrical power connector and the panel, and a freedom of movement ±2.00 mm is provided in a vertical plane between the electrical power connector and the panel.

13. The electrical power connector of claim 9, wherein each ground terminal includes a mounting portion coupled to the flange, and wherein in each ground terminal, the plurality of flexible legs and the plurality of flexible fingers extend from the mounting portion.

14. The electrical power connector of claim 9, wherein in each ground terminal, the plurality of flexible legs includes an upper flexible leg which extends vertically upward and a lower flexible leg which extends vertically downward.

15. The electrical power connector of claim 1, wherein each power terminal comprises:
a mounting portion; and
a plurality of spaced apart flexible fingers extending longitudinally forward from the mounting portion, and
wherein the mounting portion of the first power terminal is coupled to the first arm and flexible fingers of the first power terminal extend along the first arm, and the mounting portion of the second power terminal is coupled to the second arm and flexible fingers of the second power terminal extend along the second arm.

16. The electrical power connector of claim 15, in combination with a panel comprising coupled first and second walls, the arms and the flexible fingers of the ground terminal extending through the first wall, the rear section extending through the second wall, and the flexible fingers and the flange are captured between the first and second walls.

17. The combination of claim 16, wherein the first wall has a first opening which is larger than an outer profile of the arms, and the second wall has an opening which is larger than an outer profile of the rear section.

18. The combination of claim 15, further comprising a busbar and a wiring harness electrically coupled to the power terminals.

19. The combination of claim 18, wherein the busbar seats within the entrance space and engages with the flexible fingers of the power terminals.

20. The combination of claim 19, wherein the busbar is part of a busbar assembly which further comprises a ground pad, and wherein the ground pad is electrically coupled to the ground terminal.
